(19) United States
(12) Patent Application Publication
(10) Pub. No.: US 2021/0340816 A1
(43) Pub. Date: Nov. 4, 2021

(54) Ladder Safety Post Assembly

(71) Applicant: Michael Lynn Helmick, Fairmont, WV (US)

(72) Inventor: Michael Lynn Helmick, Fairmont, WV (US)

(21) Appl. No.: 17/244,678

(22) Filed: Apr. 29, 2021

Related U.S. Application Data
(60) Provisional application No. 63/017,194, filed on Apr. 29, 2020.

(51) Int. Cl. E06C 7/18

(52) U.S. Cl. CPC E06C 7/182

(57) ABSTRACT

A ladder safety post assembly is an apparatus that enables the user to safely climb in and out of manholes using the sunken ladders provided within. The apparatus may include an elongated housing, a threaded shaft, a hand wheel, a stationary rung hook, and a movable rung hook. The elongated housing provides a third point of contact for the user to hold onto when initially descending into the manhole or when coming out of the manhole. The threaded shaft enables the movement of the movable rung hook to secure the movable rung hook against a ladder rung. The hand wheel enables the user to manually rotate the threaded shaft to adjust the position of the movable rung hook along the threaded shaft. The stationary rung hook and the movable rung hook both secure the elongated housing to the sunken ladder by grabbing onto adjacent ladder rungs in a jaw-like manner.

The current application claims a priority to the U.S. provisional patent application Ser. No. 63/017,194 filed on Apr. 29, 2020.

### FIELD OF THE INVENTION

The present invention relates generally to safety tools and climbing aids utilized in skilled trades or utility work. More specifically, the present invention is a ladder safety post assembly that provides an elevated third point of contact for use while descending sunken ladders.

### BACKGROUND OF THE INVENTION

Currently, tradesmen are frequently required to descend into access hatches or manholes via sunken ladders. These ladders are, by necessity of an unobstructed hatch mating surface, out of reach by conventional means from the surface. Workers typically must support themselves on the periphery of the hatch opening as they descend until they may grasp a ladder rung directly. In other cases, they may simply be required to balance on individual rungs. In either scenario, the worker lacks a third point of contact while climbing, a shortfall recognized as a hazard when climbing in any context. It is therefore considered that a means for providing a temporary third point of contact is desirable in this scenario, such that the hatch may be cleared once work has been completed and a third point of contact is no longer required.

An objective of the present invention is to provide a portable, adjustable apparatus suitable for application to any manner of ladder as may be recognized within any trade or industry. Another objective of the present invention is to provide an assembly that may be disassembled and reconfigured into a more portable form for ease of transport between jobsites, including features that may serve as dual-purpose stowage elements and user safety elements. The assembly of the present invention is further considered to comprise multiple redundant fixtures, such that the likelihood of collapse or separation of the present invention during use is eliminated in the event of any single part failure. Additional features and benefits of the present invention are further discussed in the sections below.

### SUMMARY OF THE INVENTION

The present invention is a ladder safety post assembly that provides a temporary third point of contact for the user to safely climb a sunken ladder. Once deployed to a ladder, the user can seize the rungs of said ladder between a jaw-like structure of the present invention to fix a protruding section outside the adjacent access hatch, thereby providing a suitable third point of contact for the initial descent into said hatch. It is further considered that the present invention may be disassembled and reconfigured into a more portable form for ease of transport between jobsites, including features that may serve as dual-purpose stowage elements and user safety elements. The modular design of the present invention enables the user to comfortably carry around the disassembled present invention and deploy it whenever necessary. The present invention also comprises multiple redundant fixtures, such that the likelihood of collapse or separation of the present invention during use is reduced in the event of failure. Furthermore, the present invention can also be adjusted to fit in the hatch without hindering the work of the user, such as angling the assembly away from the hatch to not obstruct the access into the hatch by the user.

### BRIEF DESCRIPTION OF THE DRAWINGS

FIG. 1 is a top perspective view showing the present invention attached to a sunken ladder.

FIG. 2 is a side view showing the present invention attached to a sunken ladder, wherein the present invention is oriented parallel to the ladder.

FIG. 3 is a side view showing the present invention attached to a sunken ladder, wherein the present invention is oriented at an angle with the ladder.

FIG. 4 is a top exploded perspective view showing the present invention, wherein the present invention is shown fully dismantled.

FIG. 5 is a bottom exploded perspective view showing the present invention, wherein the present invention is shown fully dismantled.

FIG. 6 is a top perspective view showing the present invention.

FIG. 7 is a magnified view taken from circle 7 in FIG. 6.

FIG. 8 is a front view showing the present invention.

FIG. 9 is a cross-sectional view taken along line 9-9 in FIG. 8.

FIG. 10 is a magnified view taken from circle 10 in FIG. 9.

FIG. 11 is a rear view showing the present invention.

FIG. 12 is a cross-sectional view taken along line 12-12 in FIG. 11.

FIG. 13 is a top perspective view showing the present invention, wherein the present invention is shown dismantled for transportation and storage.

FIG. 14 is a bottom perspective view showing the present invention, wherein the present invention is shown dismantled for transportation and storage.

FIG. 15 is a front view showing the present invention, wherein the present invention is shown dismantled for transportation and storage.

FIG. 16 is a cross-sectional view taken along line 16-16 in FIG. 15.

FIG. 17 is a magnified view taken from circle 17 in FIG. 16.

### DETAIL DESCRIPTIONS OF THE INVENTION

All illustrations of the drawings are for the purpose of describing selected versions of the present invention and are not intended to limit the scope of any future claims related to the present invention.

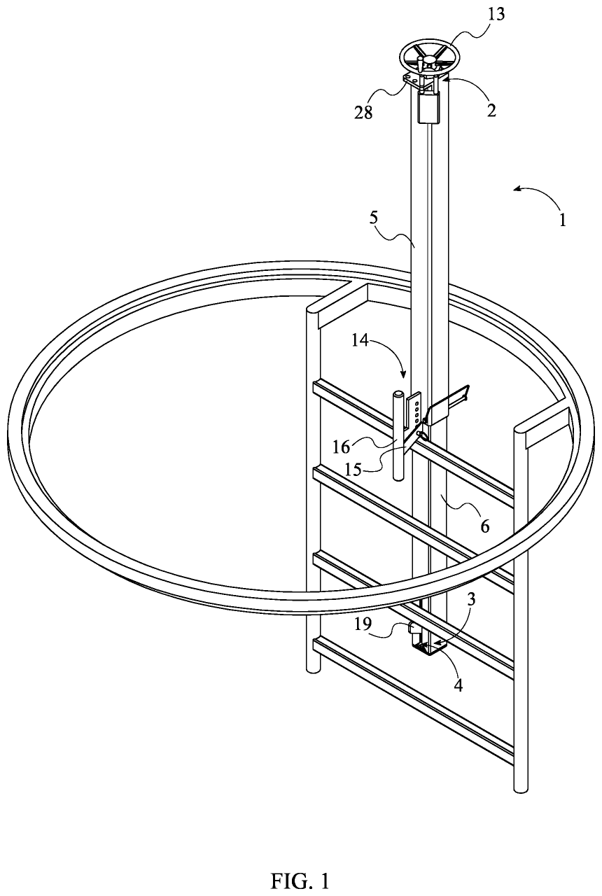

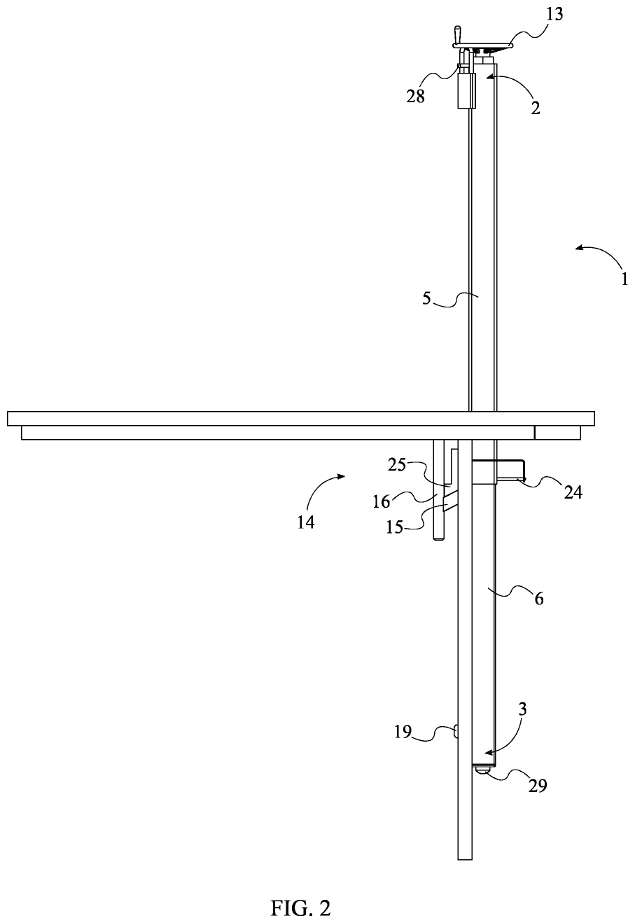

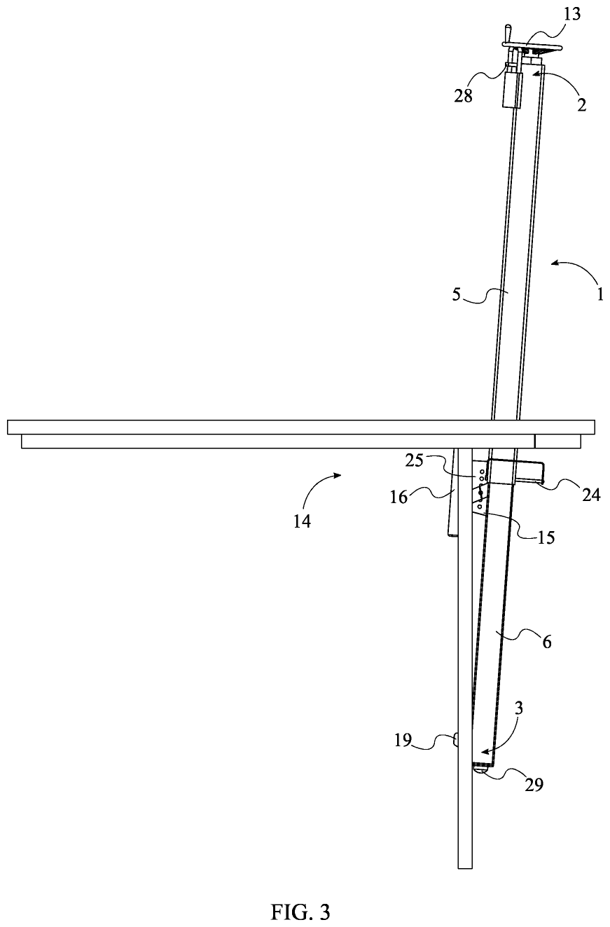

The present invention is a ladder safety post assembly that enables the user to safely climb in and out of manholes using the sunken ladders provided within. As can be seen in FIG. 1 through 5, the present invention may comprise an elongated housing 1, a threaded shaft 7, a hand wheel 13, a stationary rung hook 14, and a movable rung hook 19. The elongated housing 1 provides a third point of contact for the user to hold onto when initially descending into the manhole or when coming out of the manhole. The threaded shaft 7 enables the movement of the movable rung hook 19 to secure the movable rung hook 19 against a ladder rung. The hand wheel 13 enables the user to manually rotate the threaded shaft 7 to adjust the position of the movable rung hook 19 along the threaded shaft 7. The stationary rung hook 14 and the movable rung hook 19 both secure the elongated housing 1 to the sunken ladder by grabbing onto adjacent ladder rungs in a jaw-like manner.

The general configuration of the aforementioned components enables user to safely climb in and out of manholes without having to alter the access to the manhole. As can be seen in FIG. 1 through 5, the elongated housing 1 is preferably a long, tubular, and modular structure that can be easily set up and dismantled. The elongated housing 1 comprises a first housing end 2, a second housing end 3, and track slit 4. The first housing end 2 and the second housing end 3 correspond to the terminal ends of the elongated housing 1. The track slit 4 is a cutout on a lateral side of the elongated housing 1 that guides the movement of the movable rung hook 19 along the elongated housing 1.

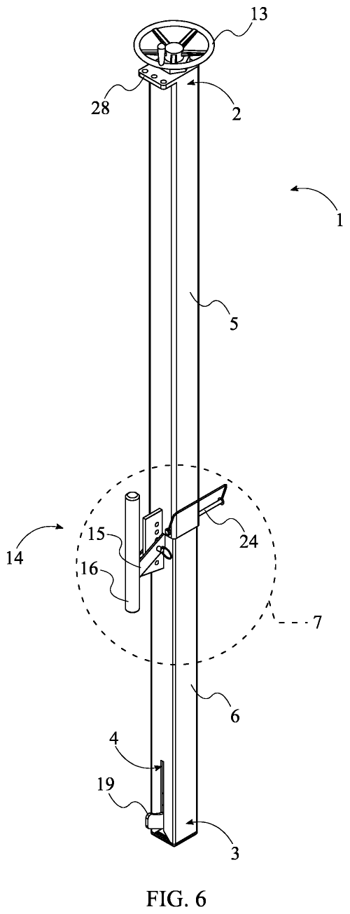

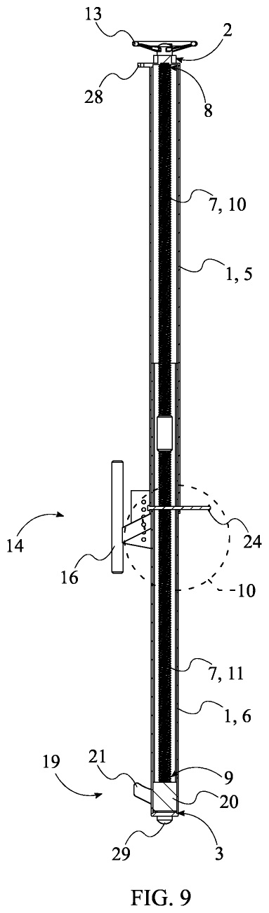

As can be seen in FIG. 6 through 9, the threaded shaft 7 is preferably a long, threaded rod that fits inside the elongated housing 1 to facilitate the movement of the movable rung hook 19. The threaded shaft 7 is positioned within the elongated housing 1 so that the threaded shaft 7 rotates within the elongated housing 1. The first shaft end 8 is rotatably mounted through the first housing end 2 so that the hand wheel 13 can be connected to the threaded shaft 7. On the other hand, the second shaft end 9 is rotatably connected to the second housing end 3 so that the threaded shaft 7 only rotates within the elongated housing 1 and does not move around. The hand wheel 13 is externally positioned to the elongated housing 1 so that the hand wheel 13 is accessible to the user. In addition, the hand wheel 13 is torsionally connected to the first shaft end 8 so that the user can manually rotate the threaded shaft 7.

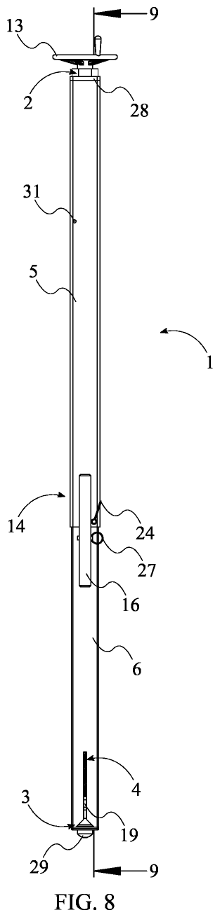

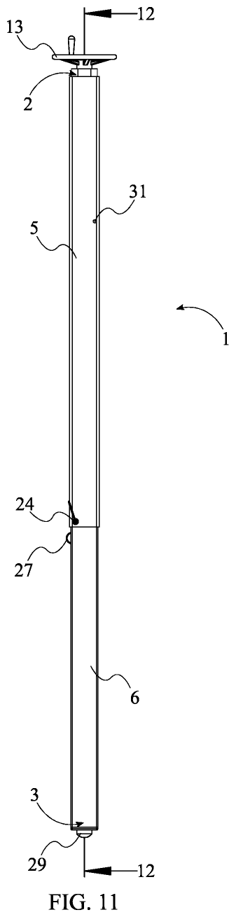

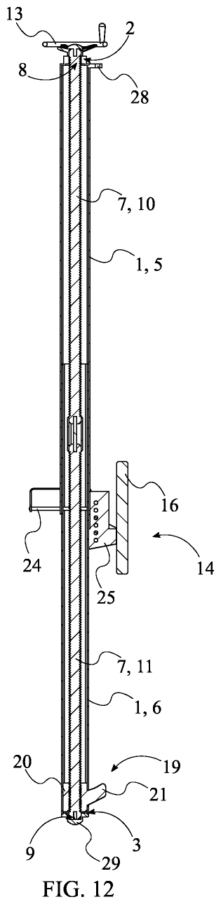

Moreover, the stationary rung hook 14 is laterally mounted onto the modular housing, offset to the second housing end 3, to engage with a ladder rung, as can be seen in FIG. 1 through 5. The track slit 4 traverses into the elongated housing 1, adjacent to the second housing end 3, to enable the movable rung hook 19 to protrude outside the elongated housing 1. The track slit 4 is also positioned along the elongated housing 1 to guide the movable rung hook 19 along the elongated housing 1. Further, the movable rung hook 19 is slidably mounted along the track slit 4 so that the movable rung hook 19 can be repositioned along the track slit 4. As can be seen in FIGS. 8, 9, 11, and 12, the movable rung hook 19 is also threadably engaged with the threaded shaft 7 so that the movable rung hook 19 moves along the track slit 4 as the threaded shaft 7 is rotated by the hand wheel 13. For example, the movable rung hook 19 can be threadably engaged with the threaded shaft 7 so that when the threaded shaft 7 is rotated clockwise using the hand wheel 13, the movable rung hook 19 will move away from the second housing end 3. Alternatively, when the threaded shaft 7 is rotated counterclockwise, the movable rung hook 19 is moved towards the second housing end 3. Thus, the user can secure the elongated housing 1 to the sunken ladder by first engaging the stationary rung hook 14 with a first ladder rung and positioning the movable rung hook 19 under a second ladder rung corresponding to the ladder rung below the first ladder rung. Then, the user engages the threaded shaft 7 using the hand wheel 13 to secure the movable rung hook 19 against the second ladder rung, thereby securing the elongated housing 1 to the sunken ladder. After the user is done using the present invention, the user can disengage the movable rung hook 19 by turning the hand wheel 13 in the opposite direction, releasing the movable rung hook 19 from the second ladder rung, and then removing the elongated housing 1 from the sunken ladder.

In order to further prevent the movable rung hook 19 from coming loose, the present invention may further comprise a hand wheel 13 lock. As can be seen in FIG. 1 through 3, the hand wheel 13 lock prevents the undesired rotation of the hand wheel 13 when the user is holding onto the elongated housing 1. The hand wheel 13 lock comprises at least one eyelet. The at least one eyelet is laterally connected to the elongated housing 1, adjacent to the first housing end 2, to receive an external lock such as a padlock. The user can then engage the padlock through the at least one eyelet and the hand wheel 13 to prevent the hand wheel 13 from rotating. In another embodiment, the hand wheel 13 lock may be a spring-loaded lock. The spring-loaded lock is laterally connected to the elongated housing 1, adjacent to the first housing end 2, so that the spring-loaded lock can be inserted through the hand wheel 13. Thus, the user can disengage the spring-loaded lock from the hand wheel 13, turn the hand wheel 13 as desired, and then release the spring-loaded lock so that the spring-loaded lock engages with the hand wheel 13. In other embodiments, the present invention may utilize different locking mechanisms for the hand wheel 13.

To facilitate the set up and dismantling of the present invention, the elongated housing 1 may further comprise a first tubular portion 5 and a second tubular portion 6.

As can be seen in FIGS. 8, 9, 11, and 12, the first tubular portion 5 and the second tubular portion 6 preferably correspond to the two halves of the elongated housing 1 that can be releasably attached to each other to form the elongated housing 1. The first shaft end 8 is terminally positioned to the first tubular portion 5 as the first tubular portion 5 preferably corresponds to the portion of the elongated housing 1 adjacent to the first housing end 2.

Further, the second tubular portion 6 is telescopically engaged to the first tubular portion 5, opposite to the first shaft end 8, so that the second tubular portion 6 can easily be attached to the first tubular portion 5. Furthermore, the second shaft end 9 is terminally positioned to the second tubular portion 6, opposite to the first tubular portion 5, as the second tubular portion 6 preferably correspond to the portion of the elongated housing 1 adjacent to the second housing end 3. In other embodiments, the elongated housing 1 may be divided into additional portions for easier transport and storage.

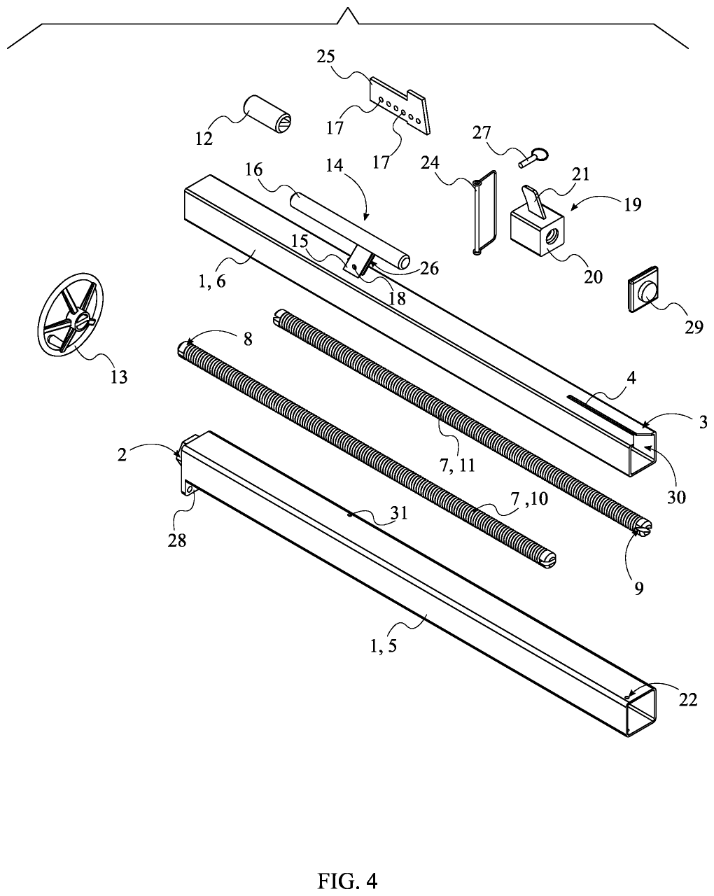

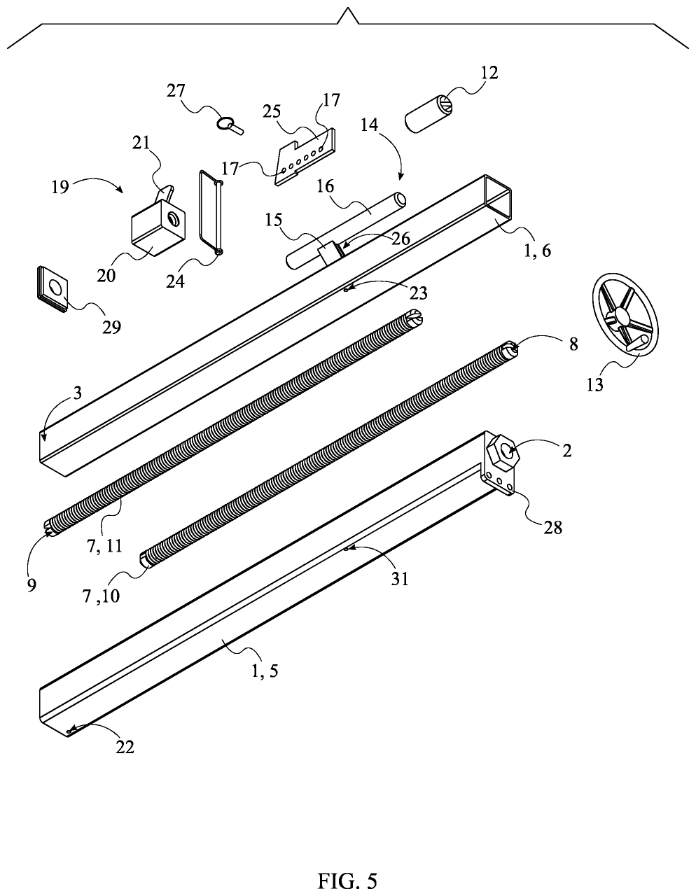

Similar to the elongated housing 1, the threaded shaft 7 may further comprise a first shaft portion 10, a second shaft portion 11, and a portion coupler 12 so that threaded shaft 7 can be set up and dismantled along with the elongated housing 1. As can be seen in FIGS. 8, 9, 11, and 12, the first shaft portion 10 is positioned along and within the first tubular portion 5, while the second shaft portion 11 is positioned along and within the second tubular portion 6. The portion coupler 12 is preferably a coupler designed to terminally engage with the first shaft portion 10 and the second shaft portion 11. For example, the portion coupler 12 can be a short, cylindrical structure with symmetrical ends. Each end of the portion coupler 12 can comprise recessions matching the shape of the ends of the corresponding tubular portion. Thus, the corresponding end of the tubular portion can be engaged with the portion coupler 12 so that both the portion coupler 12 and the tubular portions rotate together. Moreover, the first shaft end 8 is terminally positioned to the first shaft portion 10 as the first shaft portion 10 is positioned adjacent to the first housing end 2. The portion coupler 12 is terminally attached to the first shaft portion 10, opposite to the first shaft end 8, to releasably attach the portion coupler 12 to the first shaft portion 10. Further, the second shaft end 9 is terminally positioned to the second shaft portion 11 as the second shaft portion 11 is positioned adjacent to the second housing end 3. The portion coupler 12 is also terminally attached to the second shaft portion 11, opposite to the second shaft end 9, to releasably attach the portion coupler 12 to the second shaft portion 11. Thus, the first shaft portion 10 is connected to the second shaft portion 11 by the portion coupler 12, and the torsional forces applied to the first shaft portion 10 by the hand wheel 13 are transferred to the second shaft portion 11 through the portion coupler 12. In some embodiments, the present invention may further comprise a removable cap 29 that is attached onto the second housing end 3 to facilitate the removal of the second shaft portion 11 from the second tubular portion 6. As can be seen in FIGS. 4, and 5, the second housing end 3 may comprise a terminal opening 30 to accommodate the removable cap 29.

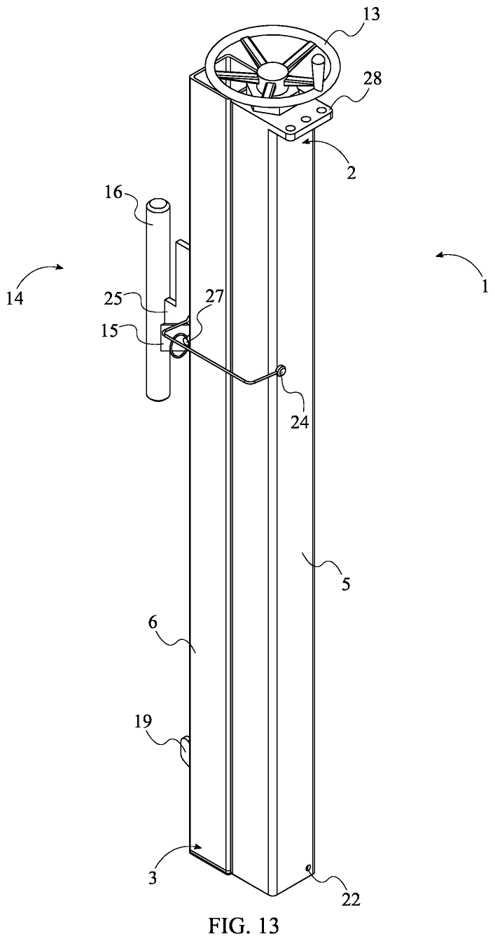

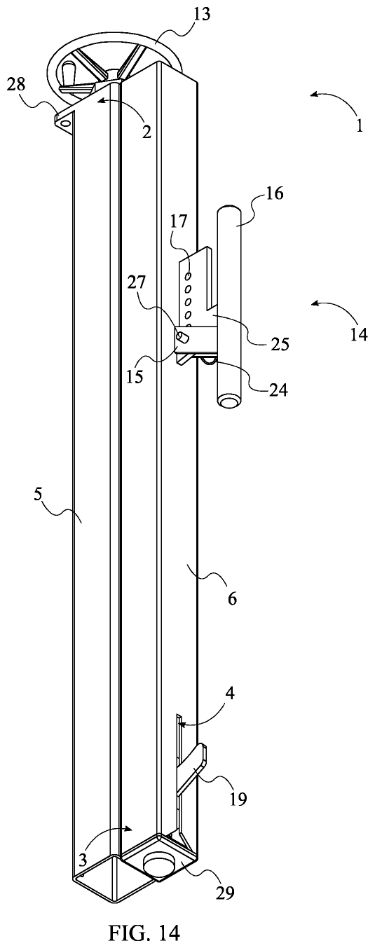

Furthermore, to secure the first tubular portion 5 to the second tubular portion 6, the present invention may further comprise a first hole 22, a second hole 23, and a pin lock 24. As can be seen in FIG. 8 through 10, the first hole 22 and the second hole 23 are provided to receive the pin lock 24 that secures the first tubular portion 5 to the second tubular portion 6. The first hole 22 traverses through the first tubular portion 5, opposite to the first housing end 2, so that the pin lock 24 is inserted through the first tubular portion 5. The second hole 23 traversers through the second tubular portion 6, opposite to the second housing end 3, so that the pin lock 24 can also be inserted through the second tubular portion 6. Further, the first hole 22 is positioned concentric to the second hole 23 so that the pin lock 24 can be inserted through the first tubular portion 5 and the second tubular portion 6. Thus, the user can secure the second tubular portion 6 to the first tubular portion 5 by engaging the pin lock 24 through the first hole 22 and the second hole 23. In addition, the pin lock 24 can be used as a handle when transporting the disassembled elongated housing 1, as can be seen in FIG. 13 through 17. The disengaged second tubular portion 6 can be positioned adjacent to the first tubular portion 5, with a third hole 31 positioned concentric to the second hole 23. Then, the pin lock 24 is engaged through the third hole 31 and the second hole 23, and the external portions of the pin lock 24 can be used as a handle. In other embodiments, other fasteners can be utilized to secure the first tubular portion 5 to the second tubular portion 6.

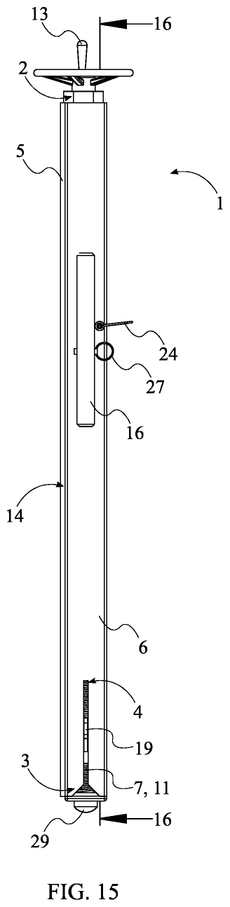

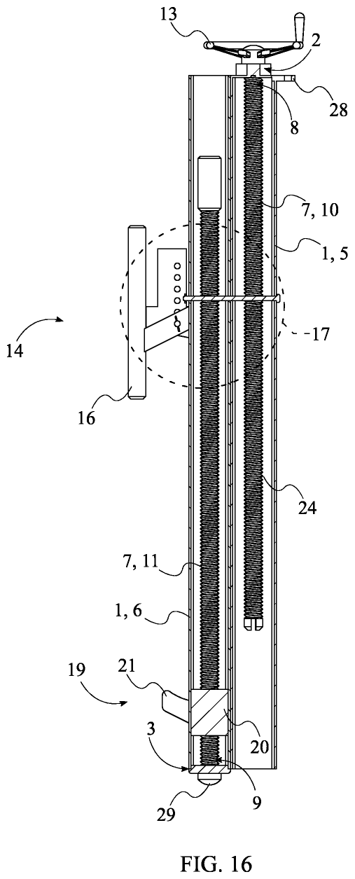

To facilitate the movement of the movable rung hook 19 along the threaded shaft 7, the movable rung hook 19 may comprise a female-threaded body 20 and a hook body 21. As can be seen in FIGS. 15 and 16, the female-threaded body 20 is designed to engage with the threaded shaft 7, while the hook body 21 is designed to engage with the desired ladder rung. The female-threaded body 20 is threadably engaged by the threaded shaft 7 so that the movable rung hook 19 is moved by the rotation of the threaded shaft 7. The hook body 21 is laterally connected to the female-threaded body 20 so that the hook body 21 is moved along with the female-threaded body 20. Further, the hook body 21 is positioned through the track slit 4 so that the hook body 21 can be engaged with the desired ladder rung. Thus, the hook body 21 can be moved up and down the elongated housing 1 along the track slit 4. In addition, to enable the hook body 21 to securely engage the desired ladder rung, the hook body 21 is positioned at an acute angle with the elongated housing 1. The hook body 21 is also away from the second housing end 3. Thus, the hook body 21 grabs onto the desired ladder rung to prevent the hook body 21 from slipping off the ladder rung. In other embodiments, the movable rung hook 19 may have different features to secure the elongated housing 1 to the ladder.

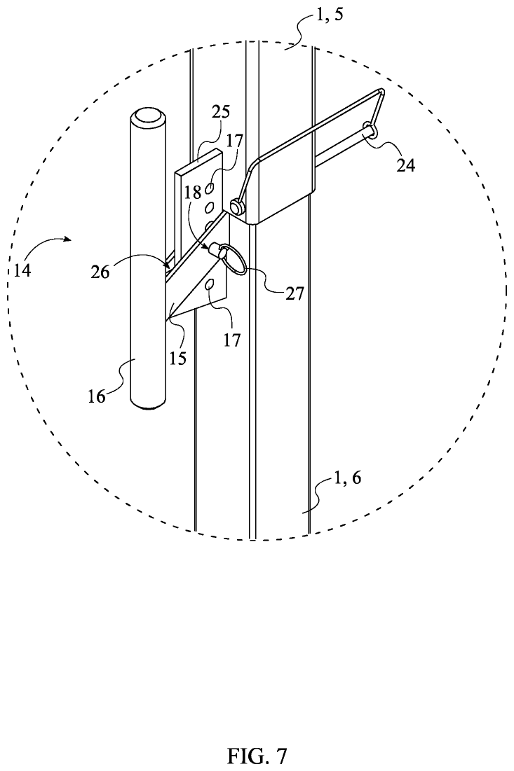

Similar to the movable rung hook 19, the stationary rung hook 14 is designed to securely grab onto the ladder rung. As can be seen in FIGS. 6 and 7, the stationary rung hook 14 may comprise a hook arm 15 and a hook handle 16. The hook arm 15 connects the hook handle 16 to the elongated housing 1, while the hook handle 16 secures the elongated housing 1 to a ladder rung. The hook arm 15 is positioned at an acute angle with the elongated housing 1 to form a corner to receive the ladder rung. The hook arm 15 is also oriented away from the first housing end 2 to form a jaw-like structure with the movable rung hook 19. Moreover, the hook handle 16 is positioned parallel and offset from the elongated housing 1 so that the hook handle 16 can be used to engage the stationary rung hook 14 with the ladder rung or to be used as a handle to carry the present invention. The hook arm 15 is also connected in between the elongated housing 1 and the hook handle 16 to connect the hook handle 16 to the elongated housing 1. Thus, the stationary rung hook 14 provides a fixed point from where the present invention can be attached to the sunken ladder. In some embodiments, portions of the hook handle 16 may be covered in padding or gripping material for easier handling and stability.

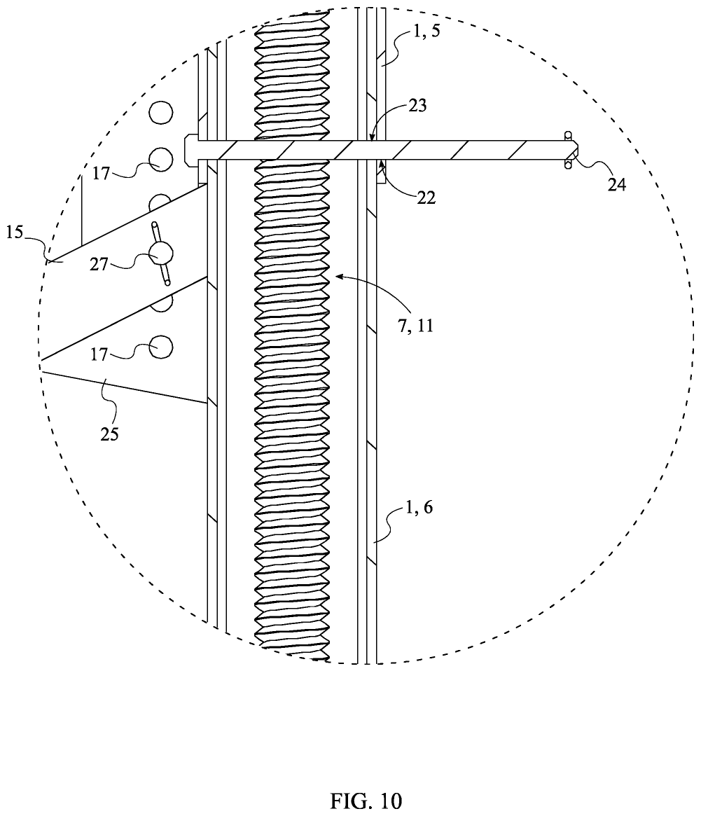

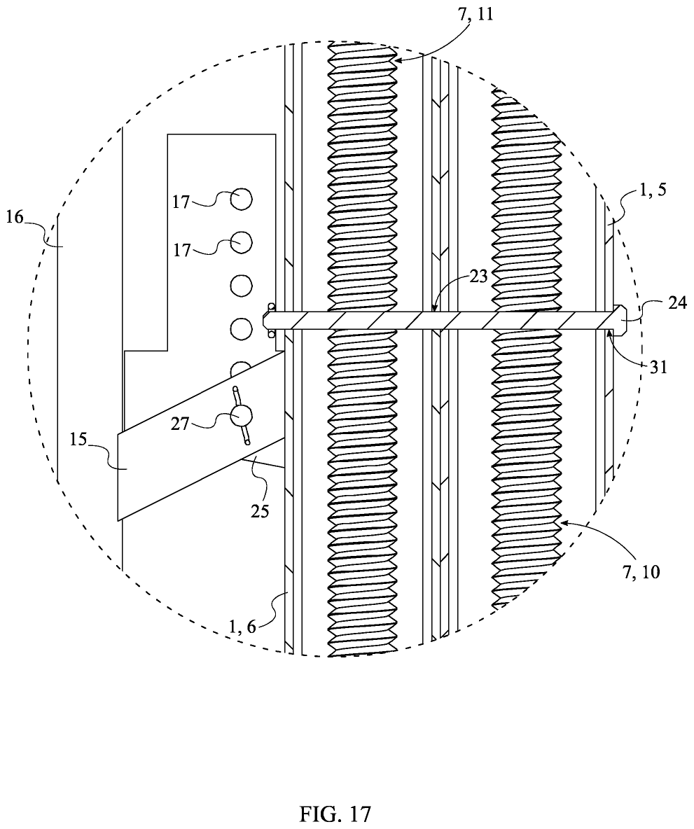

Further, the stationary rung hook 14 can provide means for the elongated housing 1 to be angled when attached to a ladder. As can be seen in FIGS. 10 and 17, the present invention may further comprise a hook wedge 25 and a wedge channel 25. The hook wedge 25 and the wedge channel 25 create an angle between the elongated housing 1 and the sunken ladder so that the elongated housing 1 does not obstruct with the movement of the user along the sunken ladder. The wedge channel 25 laterally traverses through the hook arm 15 to receive the hook wedge 25. The hook wedge 25 is slidably engaged through the wedge channel 25 so that the hook wedge 25 can be positioned at different positions along the wedge channel 25. In addition, the hook wedge 25 is positioned along the elongated housing 1 to form a wedge between the hook arm 15 and the ladder rung. Thus, the user can position the elongated holder at different angles from the ladder by increasing the wedge in between the ladder rung and the hook arm 15.

In addition, to lock the hook wedge 25 in place along the wedge channel 25, the present invention may further comprise a wedge pin lock 27. As can be seen in FIGS. 10 and 17, the stationary rung hook 14 may further comprise a plurality of wedge holes 17 and an arm hole 18 to receive the wedge pin lock 27. The plurality of wedge holes 17 laterally traverses through the hook wedge 25 so that the wedge pin lock 27 is inserted through the hook wedge 25. The plurality of wedge holes 17 is also distributed along the hook wedge 25 so that the hook wedge 25 can be repositioned along the hook arm 15. Moreover, the arm hole 18 laterally traverses through the hook arm 15 so that the wedge pin lock 27 also traverses through the hook arm 15. Thus, the user can lock the hook wedge 25 in position by engaging the wedge pin lock 27 through the arm hole 18 and a selected hole from the plurality of wedge holes 17. To adjust the position of the hook wedge 25 along the hook arm 15, the user removes the wedge pin lock 27, repositions the hook wedge 25 to a desired location, and engages the wedge pin lock 27 through the pin whole and a different hole from the plurality of wedge holes 17. In other embodiments, the present invention may utilize different means to create a wedge in between the hook arm 15 and the ladder rung.

Although the invention has been explained in relation to its preferred embodiment, it is to be understood that many other possible modifications and variations can be made without departing from the spirit and scope of the invention.

What is claimed is:

1. A ladder safety post assembly comprising:
an elongated housing;
a threaded shaft;
a hand wheel;
a stationary rung hook;
a movable rung hook;
the elongated housing comprising a first housing end, a second housing end, and a track slit;
the threaded shaft comprising a first shaft end and a second shaft end;
the threaded shaft being positioned within the elongated housing;
the first shaft end being rotatably mounted through the first housing end;
the second shaft end being rotatably connected to the second housing end;
the hand wheel being externally positioned to the elongated housing;
the hand wheel being torsionally connected to the first shaft end;
the stationary rung hook being laterally mounted onto the modular housing, offset to the second housing end;
the track slit laterally traversing into the elongated housing, adjacent to the second housing end;
the track slit being positioned along the elongated housing;
the movable rung hook being slidably mounted along the track slit; and,
the movable rung hook being threadably engaged with the threaded shaft.

2. The ladder safety post assembly as claimed in claim 1 comprising:
the elongated housing further comprising a first tubular portion and a second tubular portion;
the first shaft end being terminally positioned to the first tubular portion;
the second tubular portion being telescopically engaged to the first tubular portion, opposite to the first shaft end; and,
the second shaft end being terminally positioned to the second tubular portion, opposite to the first tubular portion.

3. The ladder safety post assembly as claimed in claim 2 comprising:
the threaded shaft further comprising a first shaft portion, a second shaft portion, and a portion coupler;
the first shaft portion being positioned along and within the first tubular portion;
the second shaft portion being positioned along and within the second tubular portion;
the first shaft end being terminally positioned to the first shaft portion;
the portion coupler being terminally attached to the first shaft portion, opposite to the first shaft end;
the second shaft end being terminally positioned to the second shaft portion; and,
the portion coupler being terminally attached to the second shaft portion, opposite to the second shaft end.

4. The ladder safety post assembly as claimed in claim 2 comprising:
a first hole;
a second hole;
a pin lock;
the first hole traversing through the first tubular portion, opposite to the first housing end;
the second hole traversing through the second tubular portion, opposite to the second housing end;
the first hole being positioned concentric to the second hole; and,
the pin lock being engaged through the first hole and the second hole.

5. The ladder safety post assembly as claimed in claim 1 comprising:
the movable rung hook comprising a female-threaded body and a hook body;
the female-threaded body being threadably engaged by the threaded shaft;
the hook body being laterally connected to the female-threaded body; and,
the hook body being positioned through the track slit.

6. The ladder safety post assembly as claimed in claim 5 comprising:
the hook body being positioned at an acute angle with the elongated housing; and,
the hook body being oriented away from the second housing end.

7. The ladder safety post assembly as claimed in claim 1 comprising:
the stationary rung hook comprising a hook arm and a hook handle;
the hook arm being positioned at an acute angle with the elongated housing;
the hook arm being oriented away from the first housing end;
the hook handle being positioned parallel and offset from the elongated housing; and,
the hook arm being connected in between the elongated housing and the hook handle.

8. The ladder safety post assembly as claimed in claim 7 comprising:
a hook wedge;
a wedge channel;
the wedge channel laterally traversing through the hook arm;
the hook wedge being slidably engaged through the wedge channel; and,
the hook wedge being positioned along the elongated housing.

9. The ladder safety post assembly as claimed in claim 8 comprising:
a wedge pin lock;
the stationary rung hook further comprising a plurality of wedge holes and an arm hole;
the plurality of wedge holes laterally traversing through the hook wedge;
the plurality of wedge holes being distributed along the hook wedge;
the arm hole laterally traversing through the hook arm; and,
the wedge pin lock being engaged through the pin hole and a selected hole from the plurality of wedge holes.

10. A ladder safety post assembly comprising:
an elongated housing;
a threaded shaft;
a hand wheel;
a stationary rung hook;
a movable rung hook;
the elongated housing comprising a first housing end, a second housing end, a track slit, a first tubular portion, and a second tubular portion;
the threaded shaft comprising a first shaft end and a second shaft end;
the threaded shaft being positioned within the elongated housing;
the first shaft end being rotatably mounted through the first housing end;
the second shaft end being rotatably connected to the second housing end;
the hand wheel being externally positioned to the elongated housing;
the hand wheel being torsionally connected to the first shaft end;
the stationary rung hook being laterally mounted onto the modular housing, offset to the second housing end;
the track slit laterally traversing into the elongated housing, adjacent to the second housing end;
the track slit being positioned along the elongated housing;
the movable rung hook being slidably mounted along the track slit;
the movable rung hook being threadably engaged with the threaded shaft;
the first shaft end being terminally positioned to the first tubular portion;
the second tubular portion being telescopically engaged to the first tubular portion, opposite to the first shaft end; and,
the second shaft end being terminally positioned to the second tubular portion, opposite to the first tubular portion.

11. The ladder safety post assembly as claimed in claim 10 comprising:
the threaded shaft further comprising a first shaft portion, a second shaft portion, and a portion coupler;
the first shaft portion being positioned along and within the first tubular portion;
the second shaft portion being positioned along and within the second tubular portion;
the first shaft end being terminally positioned to the first shaft portion;
the portion coupler being terminally attached to the first shaft portion, opposite to the first shaft end;
the second shaft end being terminally positioned to the second shaft portion; and,
the portion coupler being terminally attached to the second shaft portion, opposite to the second shaft end.

12. The ladder safety post assembly as claimed in claim 10 comprising:
a first hole;
a second hole;
a pin lock;
the first hole traversing through the first tubular portion, opposite to the first housing end;
the second hole traversing through the second tubular portion, opposite to the second housing end;
the first hole being positioned concentric to the second hole; and,
the pin lock being engaged through the first hole and the second hole.

13. The ladder safety post assembly as claimed in claim 10 comprising:
the movable rung hook comprising a female-threaded body and a hook body;
the female-threaded body being threadably engaged by the threaded shaft;
the hook body being laterally connected to the female-threaded body;
the hook body being positioned through the track slit;
the hook body being positioned at an acute angle with the elongated housing; and,
the hook body being oriented away from the second housing end.

14. The ladder safety post assembly as claimed in claim 10 comprising:
the stationary rung hook comprising a hook arm and a hook handle;
the hook arm being positioned at an acute angle with the elongated housing;
the hook arm being oriented away from the first housing end;
the hook handle being positioned parallel and offset from the elongated housing; and,
the hook arm being connected in between the elongated housing and the hook handle.

15. The ladder safety post assembly as claimed in claim 14 comprising:
a hook wedge;
a wedge channel;
a wedge pin lock;
the stationary rung hook further comprising a plurality of wedge holes and an arm hole;
the wedge channel laterally traversing through the hook arm;
the hook wedge being slidably engaged through the wedge channel;
the hook wedge being positioned along the elongated housing;
the plurality of wedge holes laterally traversing through the hook wedge;
the plurality of wedge holes being distributed along the hook wedge;
the arm hole laterally traversing through the hook arm; and,
the wedge pin lock being engaged through the pin hole and a selected hole from the plurality of wedge holes.

16. A ladder safety post assembly comprising:
an elongated housing;
a threaded shaft;
a hand wheel;
a stationary rung hook;
a movable rung hook;
the elongated housing comprising a first housing end, a second housing end, a track slit, a first tubular portion, and a second tubular portion;
the threaded shaft comprising a first shaft end, a second shaft end, a first shaft portion, a second shaft portion, and a portion coupler;
the threaded shaft being positioned within the elongated housing;
the first shaft end being rotatably mounted through the first housing end;
the second shaft end being rotatably connected to the second housing end;
the hand wheel being externally positioned to the elongated housing;
the hand wheel being torsionally connected to the first shaft end;
the stationary rung hook being laterally mounted onto the modular housing, offset to the second housing end;
the track slit laterally traversing into the elongated housing, adjacent to the second housing end;
the track slit being positioned along the elongated housing;
the movable rung hook being slidably mounted along the track slit;
the movable rung hook being threadably engaged with the threaded shaft;
the first shaft end being terminally positioned to the first tubular portion;
the second tubular portion being telescopically engaged to the first tubular portion, opposite to the first shaft end;
the second shaft end being terminally positioned to the second tubular portion, opposite to the first tubular portion;
the first shaft portion being positioned along and within the first tubular portion;
the second shaft portion being positioned along and within the second tubular portion;
the first shaft end being terminally positioned to the first shaft portion;
the portion coupler being terminally attached to the first shaft portion, opposite to the first shaft end;
the second shaft end being terminally positioned to the second shaft portion; and,
the portion coupler being terminally attached to the second shaft portion, opposite to the second shaft end.

17. The ladder safety post assembly as claimed in claim 16 comprising:
a first hole;
a second hole;
a pin lock;
the first hole traversing through the first tubular portion, opposite to the first housing end;
the second hole traversing through the second tubular portion, opposite to the second housing end;
the first hole being positioned concentric to the second hole; and,
the pin lock being engaged through the first hole and the second hole.

18. The ladder safety post assembly as claimed in claim 16 comprising:
the movable rung hook comprising a female-threaded body and a hook body;
the female-threaded body being threadably engaged by the threaded shaft;
the hook body being laterally connected to the female-threaded body;
the hook body being positioned through the track slit;
the hook body being positioned at an acute angle with the elongated housing; and,
the hook body being oriented away from the second housing end.

19. The ladder safety post assembly as claimed in claim 16 comprising:
the stationary rung hook comprising a hook arm and a hook handle;
the hook arm being positioned at an acute angle with the elongated housing;
the hook arm being oriented away from the first housing end;
the hook handle being positioned parallel and offset from the elongated housing; and,
the hook arm being connected in between the elongated housing and the hook handle.

20. The ladder safety post assembly as claimed in claim 19 comprising:
a hook wedge;
a wedge channel;
a wedge pin lock;
the stationary rung hook further comprising a plurality of wedge holes and an arm hole;
the wedge channel laterally traversing through the hook arm;
the hook wedge being slidably engaged through the wedge channel;
the hook wedge being positioned along the elongated housing;
the plurality of wedge holes laterally traversing through the hook wedge;
the plurality of wedge holes being distributed along the hook wedge;
the arm hole laterally traversing through the hook arm; and,
the wedge pin lock being engaged through the pin hole and a selected hole from the plurality of wedge holes.
